(19) United States
(12) Patent Application Publication
(10) Pub. No.: US 2018/0064034 A1
(43) Pub. Date: Mar. 8, 2018

(54) LANDSCAPING STAKE AND DRIVER

(71) Applicants: Richard Floyd Schaefer, Fort Lupton, CO (US); Gregory Lawrence Schaefer, Hudson, CO (US)

(72) Inventors: Richard Floyd Schaefer, Fort Lupton, CO (US); Gregory Lawrence Schaefer, Hudson, CO (US)

(21) Appl. No.: 15/350,250

(22) Filed: Nov. 14, 2016

Related U.S. Application Data
(60) Provisional application No. 62/382,946, filed on Sep. 2, 2016.

(51) Int. Cl. A01G 1/08; E04H 15/62; E02D 29/02

(52) U.S. Cl. CPC A01G 1/08; E02D 2600/30; E02D 29/0233; E04H 15/62

(57) ABSTRACT

Disclosed herein is a landscaping stake and related driver. Generally, the landscaping stake is directed to a stake that may be configured into a U-shape and driven into the ground to secure landscaping elements such as edging. The stake has elongated legs having a contoured profile in cross-section which makes the legs very resistant to deformation permitting the landscaping stake to be driven into hard surfaces. The driver is configured to releasably engage the upper and of the landscaping stake. The driver spreads impact forces to the legs of the landscaping stake preventing damage to the stake while it is being driven into the ground

### CROSS REFERENCE

The present application claims the benefit of the filing date of U.S. Provisional Application No. 62/382,946 having a filing date of Sep. 2, 2016, the entire contents of which is incorporated herein by reference.

### FIELD

The present disclosure is directed to an improved landscaping stake and driver. More specifically, the present disclosure is directed to a landscaping stake and driver with an improved means for driving the landscaping stake into the ground.

### BACKGROUND

Landscapers often utilizing stakes to hold landscaping structures such as edging to the ground. Such edging is often formed of pliable strips of material that separate areas of landscaping. For instance, edging is often used to separate lawns from planting beds. Landscaping stakes typically engage a portion of the landscape edging and secure it in place. For example, several stakes are positioned along the length of the edging and driven into the ground to secure the edging in a desired location. In some instances fasters are required to secure the edging to the stake. A commonly utilized landscaping stake is a u-shaped wire that extends over lawn edging and is pounded into the ground.

Inserting the stake into the ground to its proper depth may result in damage to the stake and/or edging. Typically, the stakes are pounded directly with a hammer until the stake engages the top of the edging. However, during this process the hammer can cause damage to the stake, especially when the ground is hard. That is, the process of driving the stake into the ground deforms the stake. Additionally, it is difficult to control the force applied when pounding the stake to adequately secure the edging. That, in attempting to ensure the stake securely engages the edging, excess pounding can result in damage to the edging and/or stake.

### SUMMARY

Disclosed herein is a landscaping stake and related driver. Generally, the landscaping stake is directed to a stake that may be configured into a U-shape and driven into the ground to secure landscaping elements such as edging. The stake has elongated legs having a contoured profile in cross-section which makes the legs very resistant to deformation permitting the landscaping stake to be driven into hard surfaces. The driver is configured to releasably engage the upper and of the landscaping stake. The driver spreads impact forces to the legs of the landscaping stake preventing damage to the stake while it is being driven into the ground.

According to a first aspect, a landscaping stake is provided. The landscaping stake has first and second elongated legs connected by a joint. Each of the elongated legs includes a concave/convex cross-sectional profile over at least a portion of its length. The concave/convex profile adds significant rigidity to the legs allowing the state to be driven into hard surfaces. Further, each leg includes a pointed tip on its free end and a plurality is serrated elements formed along at least a portion of the length of the legs. The serrated elements resist removal of the stake once stake is driven into the ground. The joint is deformable to allow positioning of the first and second legs and desired orientation relative to one another.

In one arrangement, the landscaping stake is formed out of a flat sheet material in a stamping process. In such an arrangement, the legs and joints are integrally formed. Further, the concave/convex profile of the legs may be formed during the stamping process. In one arrangement, the legs each have an inner concave surface and outer convex surface. That is, when the joint is deformed to dispose the legs in a spaced parallel orientation, the concave surfaces of the legs face one another. However, it will be appreciated this configuration may be reversed. In one particular arrangement, each leg has a V-shaped or L-shaped cross-sectional profile over at least a portion of its length. Other profiles may be utilized. For instance, a W-shaped cross-sectional profile may be utilized. What is important is that each leg include one or more bends or ribs that runs axially along its length to provide in improved structural rigidity.

The serrations may have any appropriate configuration. Typically, the serrations are formed on the edges of the elongated legs over a portion of the legs proximate to their tips. In one arrangement, the serrations have a sawtooth configuration having a forward edge angled from the tip toward the connecting joint. Rearward edges of the seriation are transverse to a central axis of each leg. This configuration resists removal once the stake is driven into the ground.

In one arrangement, the landscaping stake includes shoulder surfaces at the transitions between the joint and the concave/convex cross-sectional profiles of the legs. Generally, the shoulder surface is an angled surface relative to the centerline axis of the stake when the legs are disposed in a spaced parallel relationship (U-shaped configuration). This angled surface extends between the generally flat joint (e.g., in cross-sectional profile) and the contoured profile of the legs. The angled surfaces or shoulders provide a location to which driving forces may be applied in addition to the joint. That is, each leg may be driven directly into the ground.

According to another aspect, a driver is provided for driving a landscaping stake into the ground. The driver includes a generally U-shaped body having a driving surface formed on the outside surface of the closed end of the body. An inner surface of the U-shaped body is conformably shaped to the outside surface of a landscaping stake. The inner surface includes a slot section that receives a joint of a landscaping stake. In one arrangement, the slot section includes first and second spaced parallel sidewalls and a closed end. The spacing between the sidewalls allows for insertion of a joint of a landscaping stake there between. The inside surfaces of the legs (e.g., lower sections) of the U-shaped body attach to the lower ends of the slot sidewalls and flare outwards. More specifically, the lower sections angle outward from centerline axis of the driver at an angle that is substantially identical to angled surfaces toward the top ends of the legs of the landscaping stake. When placed on the landscaping stake, striking the driving surface results in impact forces being applied to the legs such the legs are driven directly into the ground.

### BRIEF DESCRIPTION OF THE DRAWINGS

FIG. 1A illustrates a perspective view of a landscaping stake in an assembled embodiment.

FIG. 1B illustrates a different perspective view of a landscaping stake with legs in a different orientation.

FIG. 2 illustrates a front view of a landscaping stake.

FIG. 3A illustrates a side view of a landscaping stake.

FIG. 3B illustrates aside view of a landscaping stake positioned relative to a piece of edging.

FIG. 3C illustrates aside view of a landscaping stake securing a piece of edging to the ground.

FIG. 3D illustrates aside view of a landscaping stake as driven in the ground showing flaring of the legs.

FIG. 4 illustrates a top/perspective view if a landscaping stake in a planar embodiment.

FIGS. 5A and 5B illustrates views of a landscape driver system.

FIG. 6 illustrates an end view of a stake being driven on a piece of landscape edging.

### DETAILED DESCRIPTION

Reference will now be made to the accompanying drawings, which at least assist in illustrating the various pertinent features of the presented inventions. The following description is presented for purposes of illustration and description and is not intended to limit the inventions to the forms disclosed herein. Consequently, variations and modifications commensurate with the following teachings, and skill and knowledge of the relevant art, are within the scope of the presented inventions. The embodiments described herein are further intended to explain the best modes known of practicing the inventions and to enable others skilled in the art to utilize the inventions in such, or other embodiments and with various modifications required by the particular application(s) or use(s) of the presented inventions.

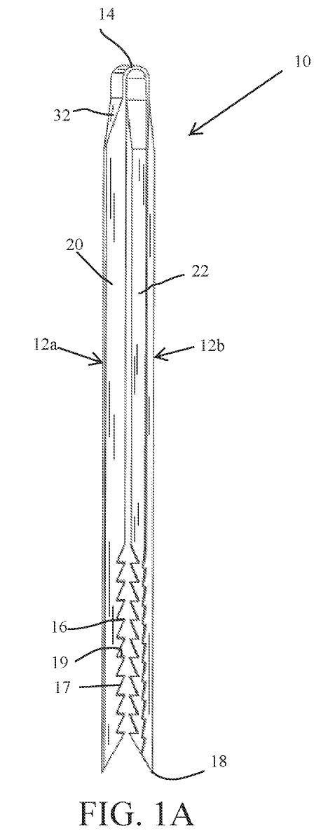

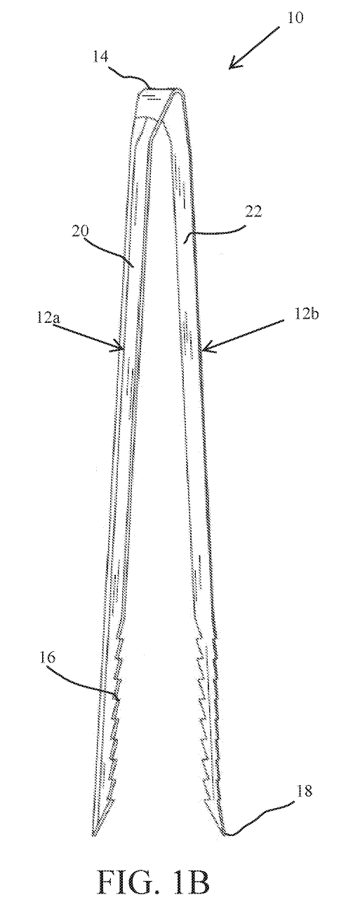

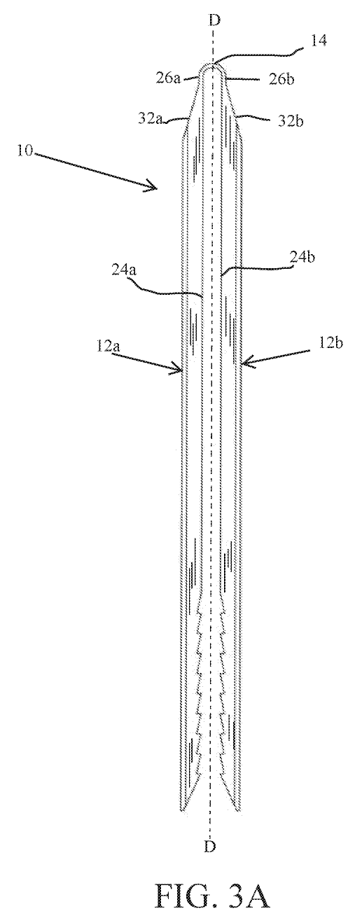

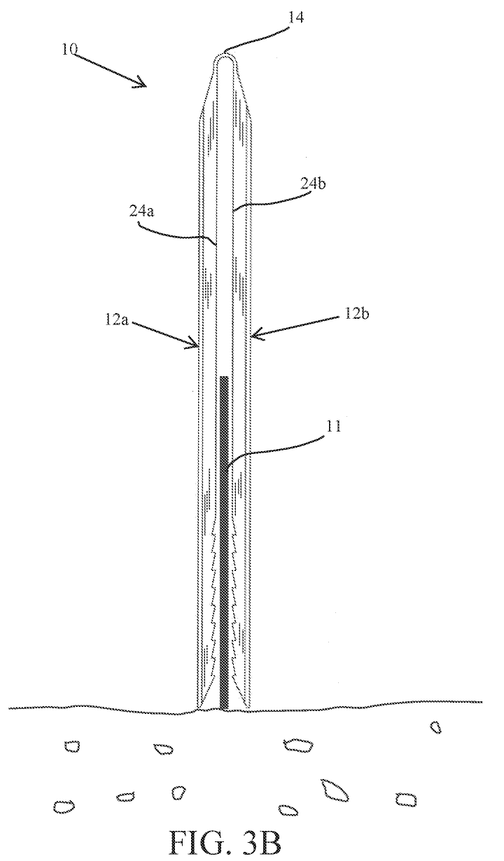

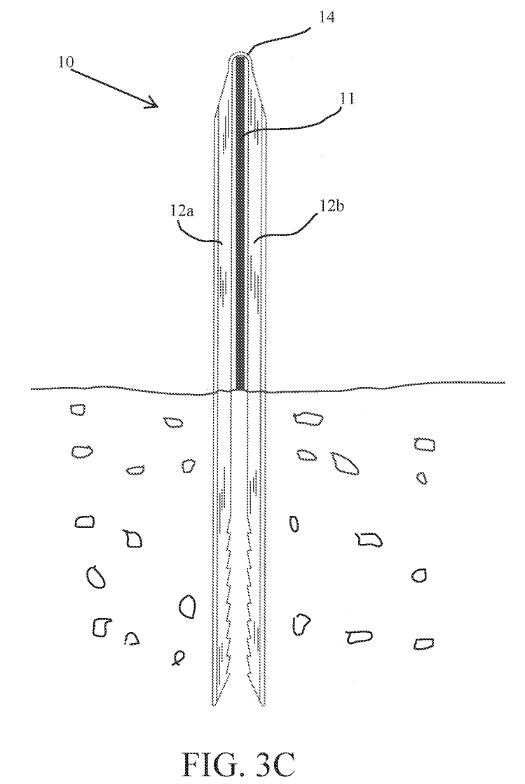

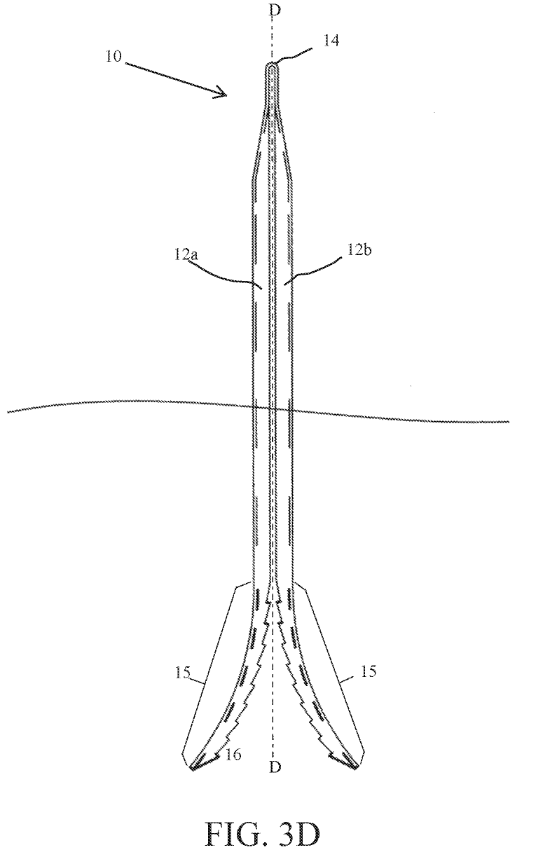

FIG. 1A illustrates one non-limiting embodiment of a landscaping stake 10 having a U-shaped configuration with first and second legs 12a and 12b (hereafter 12 unless specifically referenced) connected by a closed end or joint 14. As shown in the present configuration, the legs 12 are disposed in a substantially parallel and spaced orientation allowing each leg to penetrate or be driven into the ground to securely retain landscaping structure such as edging 11 in a desired location. That is, each leg 12 is formed of a sufficiently rigid material (e.g., steel, aluminum, plastic etc.). That contributes to the overall structural integrity of the landscaping stake when it is being driven into the ground to secure landscaping structure (e.g., edging) in a desired location. The connecting portion or joint 14 holds the legs in a spaced orientation relative to each other and also engages and secures a top end of a landscaping edging 11. See FIG. 3C.

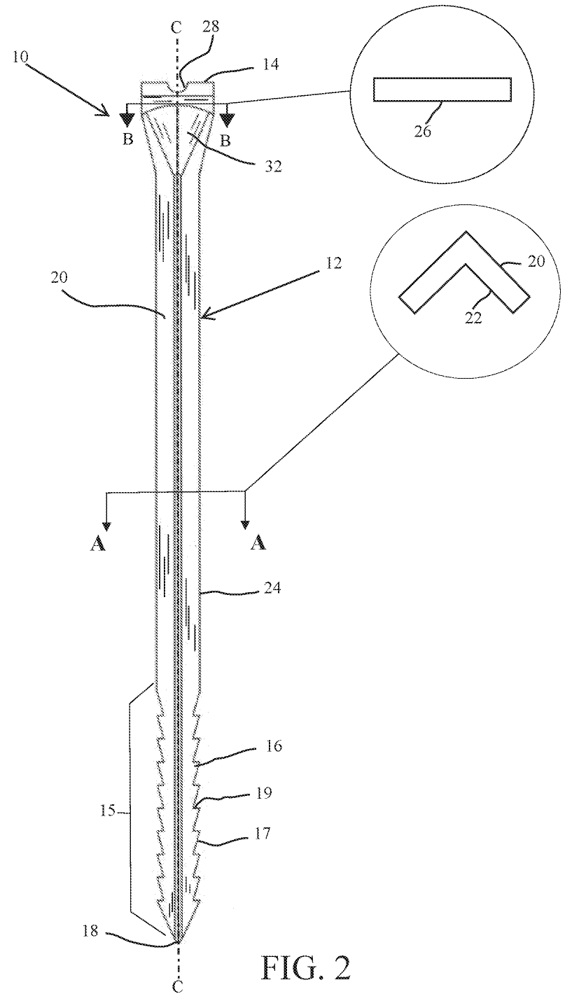

As shown in FIG. 1A, each of the legs 12 extend from the joint 14 to a pointed tip 18 on their free ends. The elongated legs have a convex outer surface 20 and a concave inner surface 22. In the present embodiment, the legs 12 are substantially v-shaped in the cross-section taken alone line A-A. See e.g., FIG. 2. However, it will be appreciated that in further embodiments the legs 12 may comprise other cross-sectional shapes (e.g., curved, parabolic etc.). In yet other embodiments the legs 12 may have a cross-sectional profile that changes over their length. The convex/concave (e.g., v-shape) profile of the legs 12 provide structural rigidity that resists deforming, bending or buckling of the stake 10 while being driven into a surface. Preferably, the convex/concave profile preferably extends over a majority of the length of the legs 12 to enhance the rigidity of the legs. In the present embodiment, the convex/concave surfaces of the legs 12 extend from shoulders 32 disposed proximate to the joint 14 to the pointed tips 18. The shoulders 32 are angled surfaces that transition from the generally flat or planar section 26 (e.g., in cross-section taken alone line B-B; FIG. 2) of the joint 14 to the convex/concave profile. Stated otherwise, the shoulders are angled relative to a centerline axis D-D of the stake 10 when the legs are disposed in parallel. See, e.g., FIG. 3A.

In any arrangement, the end section 15 of the legs 12 will have a pointed tip 18. Typically, the end sections 15 of the legs 12 will also have teeth or serrated elements 16 for anchoring the landscaping stake 10 securely in the ground. The serrated elements 16 provide a mechanism to prevent one or more legs 12 of the landscaping stake 10 from being dislodged once driven into the ground.

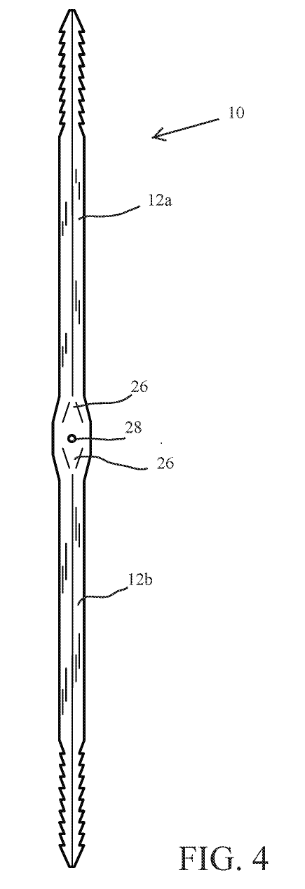

The closed end or joint 14 connects the legs 12 and the inside surface of the joint interfaces with landscaping elements such as edging 11. See FIG. 3C. As illustrated, in FIG. 1A, the joint 14 portion has a u-shaped configuration. However, the joint 14 is configured to act like a living hinge. That is, the joint is flexible. In this regard, the joint 14 portion may be deformed, to position and hold the legs 12 at various orientations in relation to each other. FIG. 1B illustrates another perspective view of the landscaping stake 10 where the joint 14 is expanded such that the legs 12 extend apart so that the legs are non-parallel. The joint 14 is sufficiently malleable for a user to be able to deform and orient the legs 12 at a desired angle relative to each other. This enables the landscaping stake 10 to be adapted to hold a variety of landscaping elements of differing shapes and configurations. Further, as will be discussed in greater detail below, the joint 14 and thus the landscaping stake may initially be in a planar orientation. That is, the joint 14 may initially be flat and the legs 12 would extend in opposite directions in a common plane (shown in FIG. 4). Hence, a user of the landscaping stake is able to exert a force on the legs 12, thereby bending the joint 14 until the legs 12 are in a desired orientation relative to each other. It will be appreciated that various relative orientations of the legs 12 in relation to each other are possible including orientations in which the legs 12 twist or rotate along their axial length.

FIG. 2 illustrates a front view of the landscaping stake 10. As shown, the stake 10 includes a plurality of saw-like serrated elements 16 forming a retaining structure on the end section 15. The serrated elements 16 may take on various configurations. In the illustrated embodiment the serrated elements 16 are formed directly in the end portions 15 of the legs 12. In the embodiment shown the serrated elements 16 are located on the edges of the legs 12 and thus are also oriented in a v-shaped cross-sectional profile. The serrated elements 16 are configured such that the leading edge 17 is sloped upward relative to the tip 18 and away from a centerline axis C-C of the leg 12, thereby decreasing the resistance to being driven into the ground or other landscaping structure. The back edge 19 extends away from the centerline axis C-C of the leg 12 at a substantially perpendicular orientation, thereby increasing the resistance of the landscaping stake 10 from being removed from the ground. However, it will be appreciated that the serrated elements 16 may take on various other forms, such as the leading edge 17 being curved and the back edge 19 extending in orientations other than perpendicular to the centerline axis C-C of the leg 12. The serrated elements 16 may also extend beyond the side edge 24 of the legs 12. Further, it is contemplated that the serrated elements 16 could be take on non-planar orientations. For example individual serrations could be positioned out of plane in relation to the outer surface 20 such that a first serration is bent forward relative to the outer surface 20 and a second adjacent serration was bent backward relative to the outer surface 20. An alternating pattern of serrated elements could be formed.

FIG. 3A illustrates a side view of the landscaping stake 10 with the legs 12 in a parallel configuration and the joint 14 bent into a u-shaped configuration. As illustrated, the joint 14 and the opposing edges 24a, 24b (hereafter 24 unless specifically referenced) of the legs 12 define a space for engaging landscaping structure such as edging 11. That is, the space defined by the legs 12 and the joint 14 may be sized such that the legs may be disposed on opposing sides of the landscaping edging 11 such that the joint 14 can be driven against a top end of the edging 11. See FIGS. 3B and 3C. The legs 12 and joint 14 can be compressed against the opposing sides of the edging 11 when the landscaping stake 10 initially engages the edging 11.

As shown the joint 14 and legs 12 form a substantially U-shaped element. However, it will be appreciated that the joint 14 could be formed to take on different shapes designed to interface with a differently configured top edge of a landscaping edging 11. For example certain edging 11 may be composed of a long strip of material having a substantially rectangular cross-section transitioning to a circular cross-sectional profile at the top edge. In this regard the joint 14 could be configured to have a complimentary circular side profile to engage with this profile of the edging 11. Embodiments such as these may further aid in securely retaining edging 11 in a desired location. It is also appreciated that, as noted above, the legs 12 may also take on various forms to similarly engage with landscaping edging 11. In this regard the joint 14 could be configured to engage with specific features of a particular edging 11 and the legs 12 could be configured to do the same.

In use, the stake 10 is positioned with a leg on either side of the edging 11. See FIG. 3B. The stake is then driven into the ground until the inside of the joint 14 contacts the top edge of the edging 11. See FIG. 3C. When driven into the ground, the serrated elements engage with the ground or other landscaping structure to resist removal of the stake 10 from a desired location.

FIG. 3D illustrates a side view of the landscaping stake as driven into the ground. Through excavation of actual stakes, it has been determined that that, when driven into hard surfaces, the end section 15 of the legs 12 tend to flare outward relative to a centerline axis D-D of the stake 10. This occurs due to the weakness on the front edges of the legs 12 caused by the serrated elements 16. That is, while being driven into the ground, the serrations permit the end sections to bend outward. This makes the stake 10 extremely resistant to removal.

FIG. 4 illustrates a non-limiting embodiment of a landscaping stake 10 in a flat configuration. More specifically, this figure illustrates the landscaping stake after manufacturing but 10 prior to use. In this configuration, the joint 14 is planar configuration and each leg 12 extends in an opposite direction along a common plane. As noted above, each of the legs 12 is an elongated element that is substantially v-shaped in cross-section and having an end portion, an outer surface and an inner surface. The joint 14 is substantially rectangular and flat, with the flat or planar sections 26 that connects the v-shaped legs 12 to the joint 14. The cross-section of the landscaping stake has a uniform thickness. However, it will also be appreciated that in further embodiments the joint 14 may take on other shapes. In any arrangement the flat joint is located between the legs 12, and designed such that applying a force to legs 12 facilitates bending of the joint 14 along its thickness.

In other embodiments the cross-section of the landscaping stake could vary along the length of the stake. For example, the cross-sectional thickness of the joint 14 could be thinner than the cross-sectional thickness of the legs 12. This may provide additional rigidity to the legs 12 when being driven into harder ground or through other landscaping structure such as clay or rocky sections. The thinner joint thickness facilitates easier bending of the joint 14 providing easy orientation of the legs 12 relative to each other. Alternatively, the cross-section of the joint 14 could be thicker than the legs 12. This may be useful in situations where increased strength is required in the joint 14, such as when holding a more heavily weighted section of edging 11 and the legs 12 don't need to be as rigid because they are being driven into softer ground.

In the illustrated embodiment the joint 14 has a relief aperture 28. The aperture 28 may be located at substantially the center of the joint 14 and is illustrated as a circular hole, though other shapes are possible. The aperture 28 facilitates bending of the joint 14 in a desired location by creating a stress concentration at locations of the aperture 28 directly adjacent the edges of the joint 14 when a bending force is applied to the stake.

The landscaping stake may be formed from a single, rectangular piece of stock material having a uniform thickness and width. In such an embodiment, the stake may be formed in a stamping process. In such a process, the cut outs that form the serrations 16 geometry and the aperture 28 are the only scrap removed from a flat sheet of material that is stamped to create the landscaping stake. However, it will be appreciated that other manufacturing techniques such as machining or molding may be selected. After a first stamping operation creating a flat piece with the landscaping stake 10 profile, a second stamping process can be used to form the desired cross-sectional configuration (e.g., v-shaped legs 12) creating the embodiment of the landscaping stake 10 shown in FIG. 4. This process minimizes the amount of scrap material thereby decreasing the cost of manufacturing.

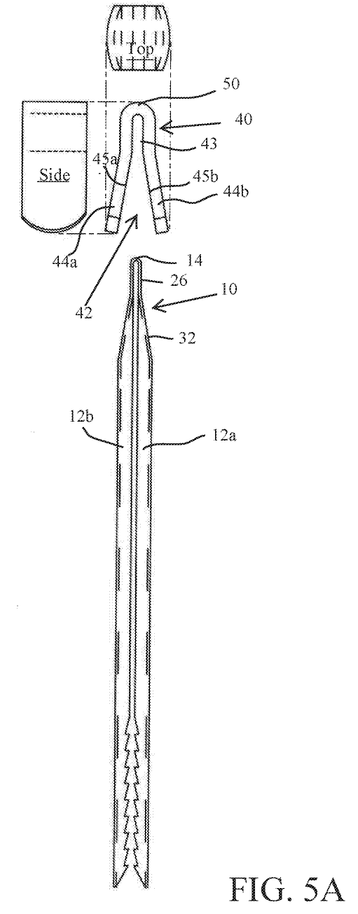

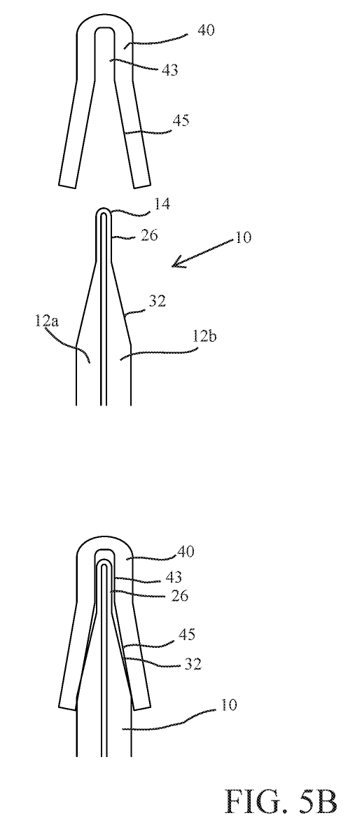

FIGS. 5A and 5B illustrate an embodiment of a driver 40 for use with the landscape stake 10. As shown, the driver 40 is removably disposed around the joint 14 and an upper section of the legs 12. That is, the driver 40 is configured to conform to the outer surface of the landscaping stake 10 and be slid onto or off of the landscaping stake 10. It has been found that, when installing a landscaping stake 10, pounding directly on the joint 14 tends to deform the joint. The driver 40 allows driving the stake 10 without deformation. That is, the heavier gauge or thickness of the driver 40 resists deformation. Further, the mating shape of the interior of the driver 40 conforms to the exterior of the stake 10 preventing deformation of the stake 10.

As shown in FIG. 5A, the driver 40 is a U-shaped element having a recessed inner surface 42 or channel sized to conformably receive the upper end of the landscaping stake 10. As shown, the inner surface 42 is defined between two legs 44a, 44b (hereafter 44 unless specifically referenced) that are attached by a closed end of the driver. The outside surface of the closed end of the U-shaped driver defines a driving surface 50. The inner surface/channel 42 has an upper slot portion 43 that is sized to conformably receive the joint section 14 of the stake 10 when the joint is bent into the illustrated U-shape. The inner surface 42 also has lower portions 45a, 45b (hereafter 45 unless specifically referenced) that are angled to approximately the same angle of the shoulders 32 of the stake. The upper slot portion 43 generally has parallel sidewalls that extend a length from the closed end of the driver that is substantially the same as the length of the joint section 14 of the stake. The lower portions 45 flare outward from the generally parallel sidewalls of the slot portion 43. Stated otherwise, the inside surface of the channel is configured to form a complimentary surface to the outside surface of the upper end of the landscaping stake 10. Thus, when the driver is impacted, the force is transferred to the closed end 14 of the stake as well as the stake shoulders 32. In this regard, the inner surface 42 of the driver contacts a substantial portion of the landscaping stake 10 it engages. This facilitates distributing at least a portion of driving forces applied to driving surface 50 of the driver 40 directly to the generally rigid convex/concave legs 12 of the landscaping stake 10. This decreases the chance that the landscaping stake 10 being damaged while being driven into the ground. Further, the contact with the inner surface of the driver legs 44 with the outer surface of the stake legs 12 prevents the upper portions of the legs 12 from spreading outward when driven into the ground.

In various embodiments the inner surface 42 of the driver may take on different complimentary shapes to the landscaping stake 10. In one example, where the profile of the legs 12 of the landscaping stake 10 are v-shaped, the inner surface 42 of the lower portions 45 could have a substantially similar or mating v-shaped profile. However, the inner surface 42 of the driver may take on any profile that facilitates receiving a portion of the landscaping stake 10, but is a different shape than the portion of the landscaping stake 10 it receives. For instance, the lower portions 45 of the surface 42 could have a curved cross-sectional profile and be operable to receive a landscaping stake 10 with legs 12 that have a v-shaped cross-sectional profile. However, any configuration will contact the shoulders of the stake to spread impact forces directly to the legs.

In the illustrated embodiment the driver 40 is U-shaped and the sides of the driver are open. The open sides coincide with the space between the two legs 12 and joint 14 of the landscaping stake 10. This configuration allows the driver to remain engaged with a portion of the landscaping stake 10 while it is being driven over a piece of edging disposed between the legs. Further, the length of the driver may be configured to correlate to the height of edging (e.g., less than the height of the edging). In this regard, when the landscaping stake 10 is being driven into the ground using the driver 40, the driver may remain engaged with the stake until the stake engages the top end of the edging.

The driver 40 may be formed from a single piece of material by a process bending and/or stamping. Although it will be appreciated that various other process such as machining or molding could be employed. In a stamping process the driver's 40 outside surface 48 could take on the same cross-sectional shape as the inner surface 42. The driving section 50 facilitates driving the landscaping stake 10 into the ground.

The heavier gauge driver 40 allows receiving a driving force such (e.g., hammer strike) without deforming. That is, the driver 40 has a thicker cross sectional profile than the landscaping stake and is made of rigid materials (e.g., aluminum, steel, plastics, etc.). In some embodiments the driving section 50 may be configured to interface with a specific driving mechanism. For example the driving section 50 may have a keyed shape (not shown) that interfaces with a complimentary interface on a driving mechanism such as a pneumatic stake driver. Further, it will be appreciated that the driving section 50 could be flat to facilitate pounding with a hammer and/or have a thicker cross-section relative to a bottom portion of the driver 40 to provide additional resistance to deformation, bending, or failure.

In other embodiments the driver 40 is assembled from multiple parts, which may be made of the same or different materials. For example, one embodiment has an inner component forming the inner surface 42 made from a plastic material. This inner component interfaces with an outer component forming the outer surface 48 and driving section 50. In this arrangement, the outer component is made from a more rigid material such as a metal or hard plastic. This configuration allows the softer inner component to provide greater cushioning to the landscaping stake 10 and/or edging 11 and facilitates removal of the driver 40 from the landscaping stake 10. The harder outer surface provides increased rigidity to resist deformation when a driving force is applied. It will be appreciated that other combinations of assemblies of multiple subcomponents forming the driver 40 are possible.

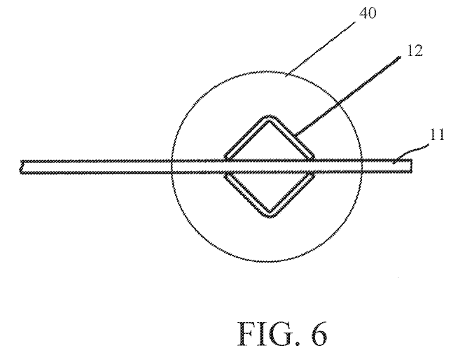

Notably, when the driver 40 is positioned on a stake, and the legs 12 of the stake are positioned on opposing sides of a piece of lawn edging (see end view FIG. 6) the stake is extremely resistant to bending. That is, the combination of the driver 40 holding the legs 12 from spreading outward with the edging 11 disposed between the legs 12 preventing deflection inward, results in a stake that can be driven through a one-inch thick piece of lumber.

Various structures of the landscaping stake introduced in FIGS. 1-6 may be varied independently of other features. It should be noted that variations of individual features are not constrained to the embodiment they are discussed in relation to. Accordingly, the various features of the landscaping stake 10 can be combined in a variety of ways to form other embodiments that are not directly discussed in this application. For example, one skilled in the art would appreciate that any of the leg cross sectional profiles (e.g., v-shaped, curved, parabolic, etc.) could be implemented with different embodiments of the serrated elements 16 (e.g., planar serrated teeth, non-planar teeth, alternating patterns of serrations, etc.).

The foregoing description has been presented for purposes of illustration and description. Furthermore, the description is not intended to limit the inventions and/or aspects of the inventions to the forms disclosed herein. Consequently, variations and modifications commensurate with the above teachings, and skill and knowledge of the relevant art, are within the scope of the presented inventions. The embodiments described hereinabove are further intended to explain best modes known of practicing the inventions and to enable others skilled in the art to utilize the inventions in such, or other embodiments and with various modifications required by the particular application(s) or use(s) of the presented inventions. It is intended that the appended claims be construed to include alternative embodiments to the extent permitted by the prior art.

What is claimed is:

1. A landscaping stake, comprising:
first and second elongated legs each having:
a concave cross-sectional profile over at least a portion of a length of said elongated leg;
a pointed tip disposed at a free end of said elongated leg; and
a plurality of serrated elements formed in at least one edge of said elongated leg proximate to said pointed tip; and
a joint formed from a planar element having a substantially uniform thickness and bent into a u-shaped configuration, the joint extending between a first end and a second end, wherein said first and second ends are substantially flat;
a first shoulder forming a first transition surface between said flat first end and said concave cross-sectional profile of said first elongated leg; and
a second shoulder forming a second transition surface between said second flat end and said concave cross-sectional profile of said second elongated leg;
wherein said joint integrally connects said first and second elongated legs, and said joint is deformable to hold said first and second elongated legs in a desired orientation relative to one another.

2. The landscaping stake of claim 1, wherein said pointed tips and said serrated elements are located on each of said concave profiles of each of said elongated legs.

3. The landscaping stake of claim 1, wherein said serrated elements are located on opposing edges of each of said elongated legs.

4. The landscaping stake of claim 1, wherein each of said concave profile has a v-shaped cross-sectional profile.

5. (canceled)

6. The landscaping stake of claim 1, wherein said u-shaped joint and said first and second elongated legs are formed from a single piece of sheet material having a substantially uniform thickness.

7. (canceled)

8. (canceled)

9. The landscaping stake of claim 1, wherein said first and second transition surfaces each comprise an angled surface oblique relative to a centerline axis of said stake when said first and second legs are disposed in parallel.

10. The landscaping stake of claim 1, further comprising an aperture extending through a central portion of said joint.

11-16. (canceled)

17. The landscaping stake of claim 9, wherein said first and second shoulders are closer together at said joint than at said concave profiles of said first and second elongated legs.

18. The landscaping stake of claim 1, wherein said u-shaped joint has a closed end that is transverse to a centerline axis of said stake, when said first and second elongated legs are disposed in parallel.

19. The landscaping stake of claim 1, wherein said joint is wider in cross-section than a distance between opposing edges of either of said first and second elongated legs.

20. A deformable landscaping stake, comprising:
a joint having a flat cross section and first and second ends, wherein said joint has a substantially uniform thickness;
first and second elongated legs each having:
a concave cross-sectional profile over at least a portion of a length of said elongated leg;
a pointed tip disposed at a free end of said elongated leg; and
a plurality of serrated elements formed in at least one edge of said elongated leg proximate to said pointed tip;
first and second shoulders integrally connecting said first end to said first elongated leg and said second end to said second elongated leg, respectively, wherein said first and second shoulders each form a transition surfaces between said flat cross-section of said joint and said concave cross-sectional profile of said first and second elongated legs;
wherein, in a first configuration said joint is substantially planar and holds said first and second elongated legs in an aligned configuration, such that long axes of said first and second legs extend along a substantially common axis; and
wherein, in a second configuration said joint is bent and holds said long axes of each said first and second elongated legs at an angle less than 180 degrees relative to each other.

21. The deformable landscaping stake of claim 19, wherein the serrated elements on each of said elongated legs extend from an outer surface to an inner surface of each of said elongated legs.

22. The deformable landscaping stake of claim 19, wherein the joint bends at a midpoint to change said landscaping stake from said first joint/elongated leg configuration to said second joint/elongated leg configuration.

23. The deformable landscaping stake of claim 19, wherein, in said second joint/elongated leg configuration, said joint is substantially u-shaped and said elongated legs are substantially parallel.

24. The deformable landscaping stake of claim 22, wherein, in said second joint/elongated leg configuration, said transition surfaces of each of said first and second shoulders is angled relative to a centerline axis extending between said first and second elongated legs.

25. The deformable landscaping stake of claim 22, wherein, in said second joint/elongated leg configuration, said first and second shoulders are closer together at said joint than at said concave profiles of said first and second elongated legs

26. The deformable landscaping stake of claim 19, further comprising an aperture extending through a central portion of said joint.

27. The deformable landscaping stake of claim 19, wherein said joint, said first and second elongated legs, and said first and second shoulders are formed from a single piece of material.

28. The deformable landscaping stake of claim 27, wherein said single piece of material comprises a flat piece of rectangular metal stock.

29. The deformable landscaping stake of claim 19, wherein said joint is wider in cross-section than a distance between opposing edges of either of said first and second elongated legs.
